(19) United States
(12) Patent Application Publication
(10) Pub. No.: US 2026/0096544 A1
(43) Pub. Date: Apr. 9, 2026

(54) OCEAN SAFE EEL TRAP ENTRY

(71) Applicants: University of Rhode Island Board of Trustees, Kingston, RI (US); Thomas C. Hansen, Rohnert Park, CA (US)

(72) Inventors: Thomas C. Hansen, Rohnert Park, CA (US); Melissa M. Omand, Tomales, CA (US)

(73) Assignee: University of Rhode Island Board of Trustees, Kingston, RI (US)

(21) Appl. No.: 19/348,849

(22) Filed: Oct. 3, 2025

Related U.S. Application Data
(60) Provisional application No. 63/703,975, filed on Oct. 6, 2024.

(51) Int. Cl. A01K 69/08

(52) U.S. Cl. CPC A01K 69/08

(57) ABSTRACT

A marine animal trap entry is assembled from a plurality of identically molded, semi-circular mating sections each including a semi-circular base and a plurality of flexible tapered fingers extending from the base. The plurality of mating sections are detachably assembled together to form an annular base portion and a tapered conical entry portion formed by the plurality of flexible tapered fingers. The plurality of fingers taper inwardly towards an apex of the conical entry portion wherein the annular base portion and conical entry portion are co-axial along a longitudinal axis of the trap entry. The semicircular mating sections are separated parallel to the axis of the trap entry. The plurality of flexible fingers are curved with an inwardly facing convex surface. Each of the semi-circular mating sections is molded from a biodegradable polymer.

### CROSS-REFERENCE TO RELATED APPLICATIONS

This application claims the benefit of U.S. Provisional Patent Application No. 63703975, filed October 6, 2024, the entire contents of which are incorporated herein by reference.

### STATEMENT OF GOVERNMENT INTEREST

This invention was made with government support under Grant Award #2230641 awarded by the National Science Foundation. The government has certain rights in the invention.

### BACKGROUND OF THE DISCLOSURE

### Field of the Invention

The instant invention relates generally to marine animal traps, and more particularly to an improved “ocean-safe” eel trap entry or gate assembly.

### Description of Related Art

The marine sector produces significant amounts of plastic debris, including an abundance of discarded single-use products and abandoned, lost, or discarded fishing and aquaculture gear. This plastic debris is responsible for billions of dollars of damage to marine ecosystems annually. Debris from marine industries represents a substantial percentage of the plastic found in the subtropical gyres and North Pacific garbage patch, it is the number one source of plastic debris on the nearshore seafloor in North America, and it is a significant component of shoreline debris on US Pacific Islands and US Territories in the Caribbean. Debris from commercial fishing and aquaculture is also associated with large mammal entanglements.

Eel traps generally consist of a cylindrical cage-like trap body, usually made of metal, and a plastic-molded, funnel-like entry collar or gate with a plurality of flexible plastic fingers. When an eel is entering the trap, the fingers can flex to allow the eel to enter but then are resilient enough to spring back together once the animal is in the trap. The current plastic fingers are resilient but over time, the plastic degrades, and the fingers spread apart and deform to allow the animals to exit the trap as well as enter. The trap entry collar is replaceable on the trap body when the plastic fingers are deformed or broken and no longer are functional.

The current design of injection molded trap entry collars uses a continuous, unitary ring of polyolefin plastic, such as polyethylene and polypropylene, as part of the funnel shape of the entry. Polyolefin plastics are less dense than water, and so once discarded or separated from the trap, the current eel trap entries therefore float on the ocean surface.

The current eel trap entry collar is thus a primary marine debris concern as the current trap entries are frequently observed stuck on the snouts of marine mammals, preventing them from eating and causing starvation. Marine animals (such as monk seals) that are curious can “investigate” the floating conical ring. Occasionally they will push at the ring with their mouth or snout. The ring is of a size where it fits over the snout of seals or turtles. When this happens, the ring can get lodged over the snout and prevent the animal from eating. The cone-shaped ring of plastic is not able to be easily dislodged from marine life once lodged in place. These mammals typically do not have means to remove the ring, so they do not survive. When the carcass of the animal decomposes, the trap collar ring floats off and can harm other animals. It is estimated that there may be as many as ten million eel trap entry collars currently adrift in the subtropical North Pacific.

### SUMMARY OF THE DISCLOSURE

The invention offers a solution to the deficiencies of the above-noted prior art via a new structural eel trap entry design that addresses the problems of both plastic marine debris and marine mammal by-catch.

According to exemplary embodiments of the invention, an improved “ocean-safe” eel trap entry may comprise three main improvements, namely the use of an ocean biodegradable plastic material, such as polyhydroxyalkanoate (PHA) that is proven to fully biodegrade in sea water, the provision of an improved structural shape for the plastic fingers which increases service life of the trap entry, and the provision of an improved structural collar design that uses multiple snap-together sections which are easily separated from each other once removed from the cage body to reduce by-catch.

Objectives of the invention may include: 1) a reduction of ocean plastic debris by being injection molded from a proven biodegradable plastic, and 2) a structural design that reduces marine mammal by-catch.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWINGS

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective view of an exemplary embodiment of a marine animal trap assembly including a cage-like trap body and a trap entry assembly in accordance with the teachings of the present disclosure;

FIG. 2 is a perspective view of the trap entry assembly;

FIG. 3 is another perspective view thereof; and

FIG. 4 is a perspective view of a single molded section of the trap entry assembly.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

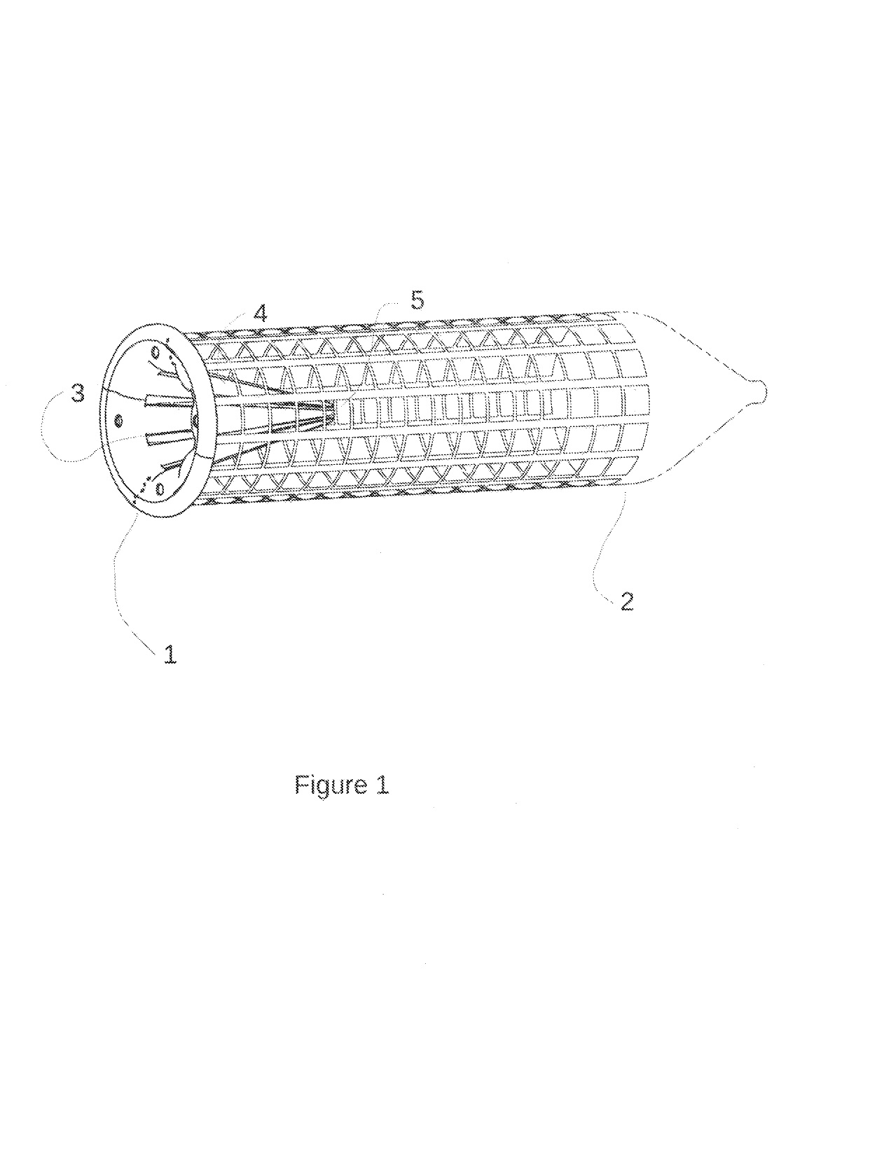

Referring to FIG. 1, a marine animal trap may comprise a cage-like trap body 2, usually made of metal, and a plastic-molded, funnel-like entry collar or gate 1 with a plurality of flexible plastic fingers 4. The eel trap entry 1 is generally conical in shape with a circular base portion 6 that affixes to the open end of the trap body 2, and a narrowing cone portion divided into a plurality of slender fingers or blades 4. The larger end of the hollow cone is continuous circular opening 3 for the animal to enter. The smaller end of the cone 5, where the tapered finger 4 meet, prevents the animal from escaping once inside the trap. As an animal enters, the slender blades 4 flex to allow the animal access to the interior of the trap 2. Once inside the blades 4 return to their original shape which closes the opening. An exemplary fishery for the present entry gate is for Hagfish also known as Slime Eels. Because of the slender body shape of the eels, the design of the trap entry depends highly on the flexibility and resiliency of the fingers. If the fingers are not flexible enough the animal cannot gain access to the interior of the trap. If the fingers are too flexible, then the opening does not close, and the animal can easily exit the trap.

The present inventive design addresses two key challenges. 1) Structural modifications required for injection molding from biodegradable polymers and prolonged service life, and 2) structural modifications required to reduce or eliminate marine mammal by-catch and shoreline debris. Currently available biodegradable injection moldable plastics have different properties (higher brittleness) compared to the polyolefin plastics currently used for eel trap entries. When the prior art design of the eel trap entry is made with biodegradable plastic (Injection molding grade PHA), the part does not function properly and is easy to break.

To overcome the limitations imposed by using more brittle biodegradable materials and wear and tear from repeated use, the inventive design employs a structural shape to supplement the properties of the plastic. To achieve the same flexibility the plastic needs to be made thinner. However, thin plastic can lose the ability to recover it original shape sooner than a thicker plastic. So rather than depending on the specific properties of a type or grade of plastic, a structural shape is used in this invention. The prior art design of the fingers of an eel trap entry is flat (planar) conically tapered blade.

The present inventive design uses a curved tapered blade with. A concave blade shape is flexible inward and very stiff outward or to the side. This design provides the blades with the correct action for use in an ETE. A much greater range in the property of flexibility of the plastic can be used with this design.

To prevent other marine mammals from becoming entrapped, the inventive design uses a cone that is separated parallel to and-or coincident to the axis of the cone. The present eel trap entry 1 is constructed from an assembly of two identical semicircular parts rather than a single part constructed as a complete circle. The design uses two identical semicircular parts which “snap” together to form the circular cone of the eel trap entry. Each part individually does not form a complete circular shape. The interface to align and connect the sections together is a simple post and hole configuration provided on overlapping tabs. This connection is easy to assemble when attaching the eel trap entry 1 to a trap 2 and will easily disassemble if the eel trap entry 1 is dislodged or removed.

Referring now to the drawing figures, FIG. 1 is a perspective view of an exemplary marine animal trap commonly utilized for slime eels or hagfish. The eel trap consists of a conical trap entry 1 and a typically cylindrical tap body 2. The large opening 3 of the trap entry 1 allows the hagfish to enter where the flexible fingers 4 can move out of the way to allow the passage of the hagfish through the smaller apex opening 5 at the apex end of the entry cone.

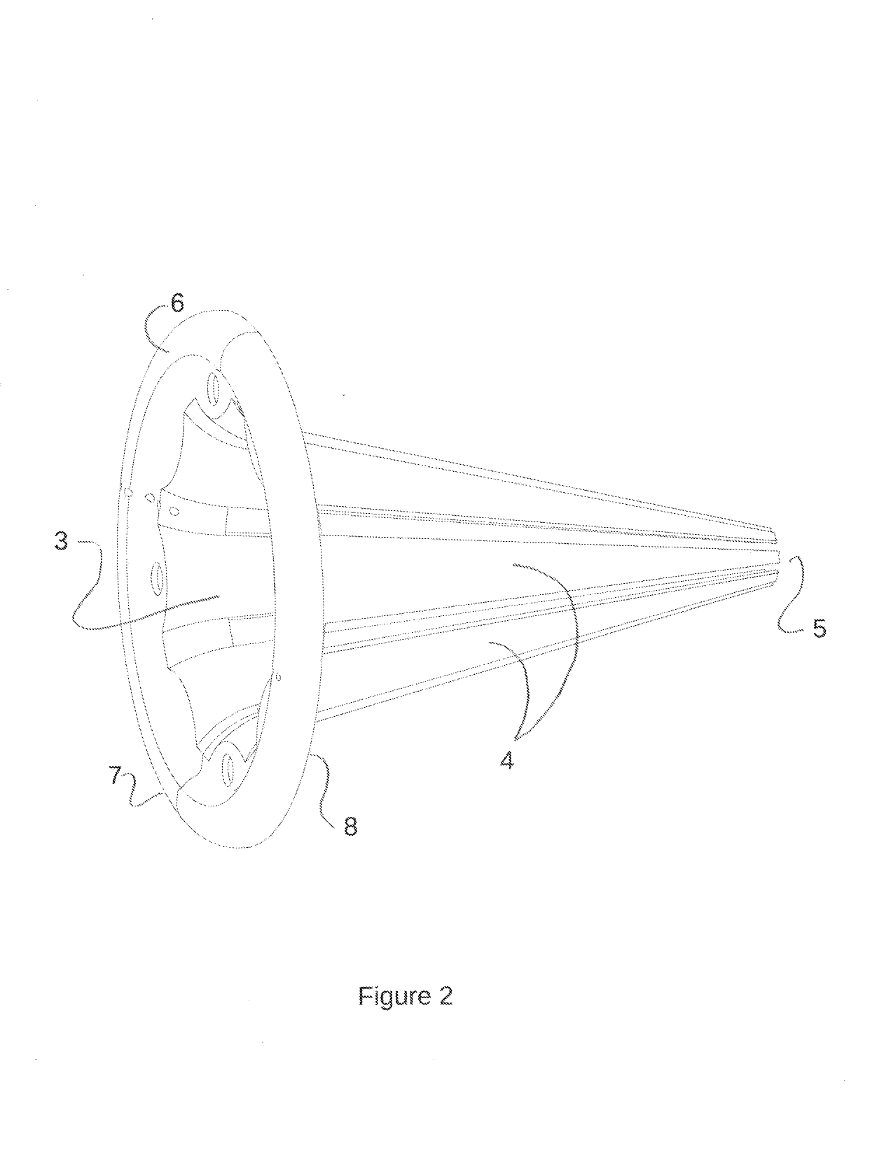

FIG. 2 shows the trap entry. For an animal to enter, the larger opening 3 leads through flexible fingers 4 to the small apex opening 5 of the trap entry. There is a circular base 6 which is used to align the entry with the trap body. FIG. 2 also clearly illustrates and shows that the trap entry 1 is composed of two identical molded sections identified as 7 and 8.

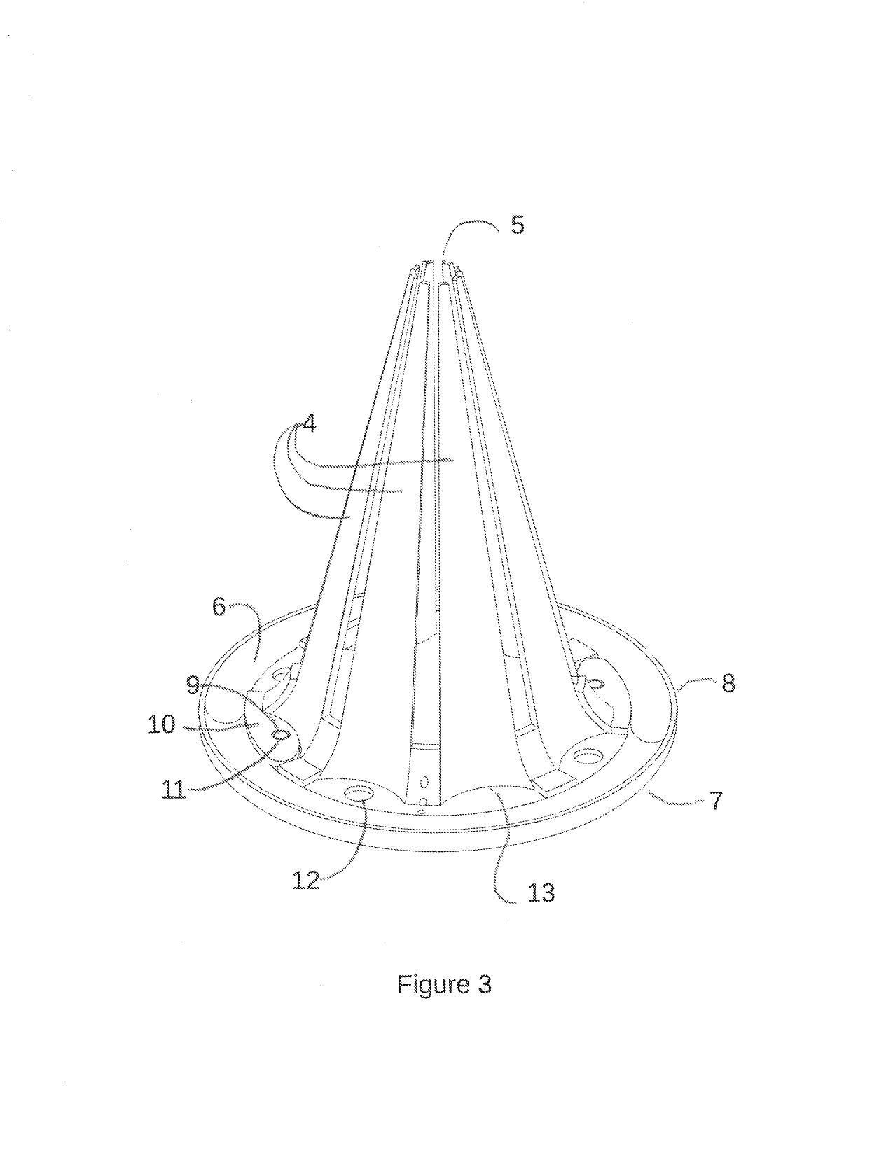

FIG. 3 is another view of the trap entry 1 oriented so that the various features of the trap entry 1 are visible. The fingers 4 are shown and the small entryway into the small opening is shown as 5. The large opening 3 which forms the circular base 6 is also shown and the two identical pieces are shown as 7 and 8. In the exemplary embodiment, the two identical parts which form the entry 1 are aligned and detachably mated together with a post 9 which fits into tab 10 through hole of 11. To attach the entry structure to the trap body holes 12 are provided. Typically, the attachment to the trap body 2 is accomplished using nylon ties or decomposable twine or cord (not shown). FIG. 3, also shows that the fingers are curved along their tapered length, most clearly illustrated by the curve 13 where each finger 4 meets the base 6.

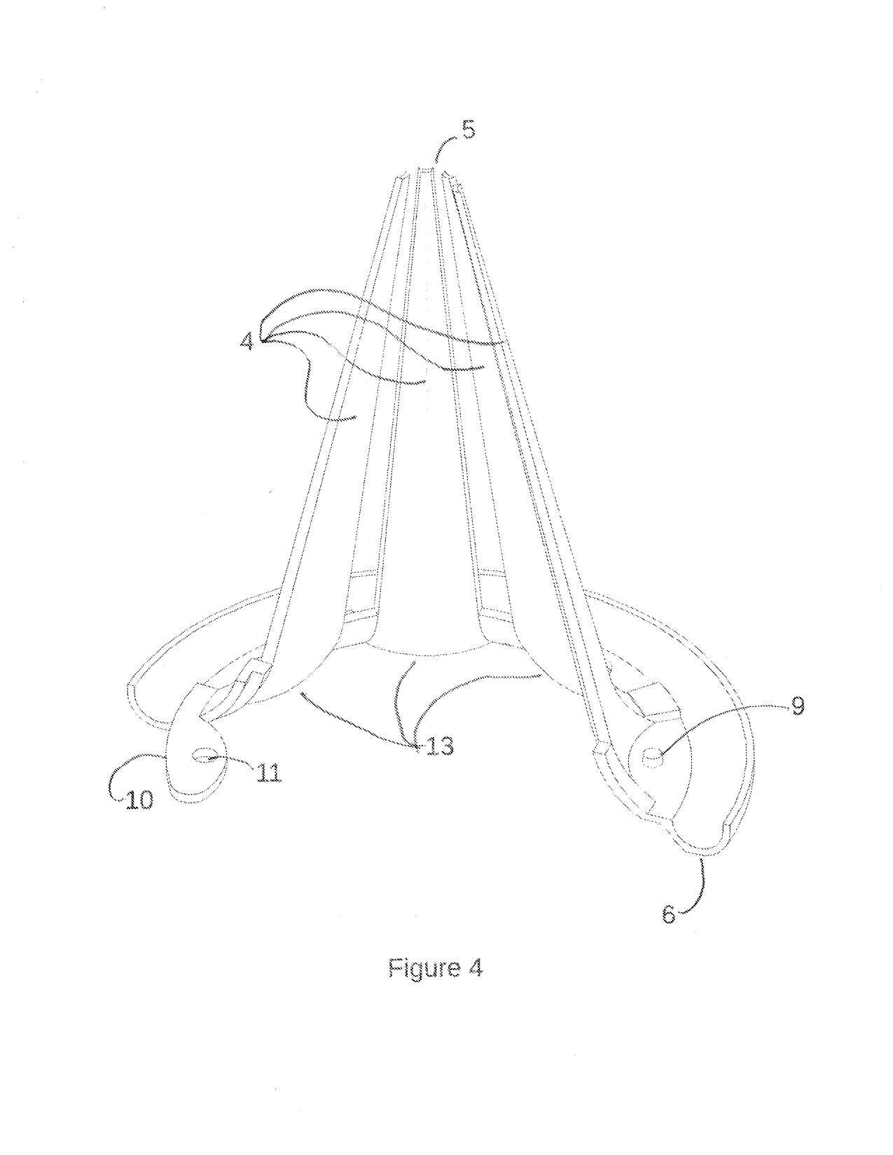

FIG. 4 illustrates a single molded section 8 of the eel trap entry 1. Corresponding parts as illustrated in FIG. 3 are listed with the same numbers such as the circular base 6, the alignment post 9, hole 11, and the attachment tab 10 are shown as well. The small opening 5 and the various fingers 4 are also shown, as is the concave curvature of the fingers 13.

Objectives of the invention include the provision of:

A marine animal trap entry comprising:

a plurality of semi-circular mating sections each comprising a semi-circular base and a plurality of flexible tapered fingers extending from the base,

wherein the plurality of mating sections are detachably assembled together to form an annular base portion and a tapered conical entry portion formed by said plurality of flexible tapered fingers, said plurality of fingers tapering inwardly towards an apex of the conical entry portion,

wherein the annular base portion and conical entry portion are co-axial along a longitudinal axis of the trap entry,

wherein the semicircular mating sections are separated parallel to the axis of the trap entry.

A marine animal trap entry wherein the plurality of flexible fingers are curved with an outwardly facing concave surface.

A marine animal trap entry wherein each of the semi-circular mating sections is identical.

A marine animal trap entry wherein each of the semi-circular mating sections is molded from a biodegradable polymer.

A marine animal trap entry wherein adjacent surfaces of semicircular base portions include interfitting snap-together mating formations.

A marine animal trap entry wherein the snap-together formations may comprise overlapping tabs with cooperating post and hole configurations.

A marine animal trap entry wherein the semicircular base of each mating section includes at least one securing opening for attaching the trap entry to the trap body.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A marine animal trap entry comprising:
a plurality of semi-circular mating sections each comprising a semi-circular base and a plurality of flexible tapered fingers extending from the base,
wherein the plurality of mating sections are detachably assembled together to form an annular base portion and a tapered conical entry portion formed by said plurality of flexible tapered fingers, said plurality of fingers tapering inwardly towards an apex of the conical entry portion,
wherein the annular base portion and conical entry portion are co-axial along a longitudinal axis of the trap entry,
wherein the semicircular mating sections are separated parallel to the axis of the trap entry.

2. The marine animal trap entry of claim 1 wherein the plurality of flexible fingers are curved with an outwardly facing concave surface.

3. The marine animal trap entry of claim 1 wherein each of said semi-circular mating sections is identical.

4. The marine animal trap entry of claim 2 wherein each of said semi-circular mating sections is identical.

5. The marine animal trap entry of claim 1 wherein each of said semi-circular mating sections is molded from a biodegradable polymer.

6. The marine animal trap entry of claim 2 wherein each of said semi-circular mating sections is molded from a biodegradable polymer.

7. The marine animal trap entry of claim 3 wherein each of said semi-circular mating sections is molded from a biodegradable polymer.

8. The marine animal trap entry of claim 4 wherein each of said semi-circular mating sections is molded from a biodegradable polymer.

9. The marine animal trap entry of claim 1 wherein adjacent surfaces of each semicircular base include interfitting snap-together mating formations.

10. The marine animal trap entry of claim 9 wherein the snap-together formations comprise overlapping tabs with cooperating post and hole configurations.

11. The marine animal trap entry of claim 1 wherein the semicircular base of each mating section includes at least one securing opening.

12. The marine animal trap entry of claim 2 wherein adjacent surfaces of each semicircular base include interfitting snap-together mating formations.

13. The marine animal trap entry of claim 12 wherein the snap-together formations comprise overlapping tabs with cooperating post and hole configurations.

14. The marine animal trap entry of claim 2 wherein the semicircular base of each mating section includes at least one securing opening.

15. The marine animal trap entry of claim 3 wherein adjacent surfaces of each semicircular base include interfitting snap-together mating formations.

16. The marine animal trap entry of claim 15 wherein the snap-together formations comprise overlapping tabs with cooperating post and hole configurations.

17. The marine animal trap entry of claim 3 wherein the semicircular base of each mating section includes at least one securing opening.

18. The marine animal trap entry of claim 4 wherein adjacent surfaces of each semicircular base include interfitting snap-together mating formations.

19. The marine animal trap entry of claim 18 wherein the snap-together formations comprise overlapping tabs with cooperating post and hole configurations.

20. The marine animal trap entry of claim 1 wherein the semicircular base of each mating section includes at least one securing opening.
